(19) United States
(12) Patent Application Publication
(10) Pub. No.: US 2022/0240542 A1
(43) Pub. Date: Aug. 4, 2022

(54) MATURATION OF IMMUNE AND METABOLIC PROCESSES VIA ALGAL BIOMASS AND/OR RELATED MATERIAL ADMINISTERED TO ANIMALS

(71) Applicant: ZIVO Bioscience, Inc., Keego Harbor, MI (US)

(72) Inventors: William P. Pfund, Kalamazoo, MI (US); Amy E. Steffek, Royal Oak, MI (US); Andrew A. Dahl, Bloomfield Hills, MI (US)

(73) Assignee: ZIVO Bioscience, Inc., Keego Harbor, MI (US)

(21) Appl. No.: 17/587,582

(22) Filed: Jan. 28, 2022

Related U.S. Application Data
(60) Provisional application No. 63/143,444, filed on Jan. 29, 2021.

(51) Int. Cl. A23K 10/10; A23K 50/75; A23K 20/163

(52) U.S. Cl. CPC A23K 10/10; A23K 20/163; A23K 50/75

(57) ABSTRACT

A method and compound for promoting growth and priming the immune system in both animals and humans are disclosed. The disclosed method utilizes a compound derived from one or more of a lipopolysaccharide, Lipid A, and fractions, derivatives, and cellular components thereof of gram-negative bacteria. The compound is combined with conventional feed, such as corn-soy feed, for administration to animals, such as poultry. Human application is possible, as well. Kinomic analysis of tissues collected from sacrificed birds fed the dietary mixture of the inventive compound and conventional feed suggests that the biomass causes an alteration of signaling in multiple growth-related pathways. These pathways include, but are not limited to, those associated with the vascular endothelial growth factor (VEGF), the mitogen-activated protein kinase (MAPK or MAP kinase), Ak strain transforming (Akt), and the neurotrophic tropomyosin-related kinase (NTRK). Evidence supports the conclusion that this alteration represents the modulation of the various pathways.

### CROSS REFERENCE TO RELATED APPLICATION

This application is a U.S. Non-provisional patent application of U.S. Provisional Patent Application No. 63/143,444, entitled “Maturation of Immune and Metabolic Processes Via Algal Biomass and/or Related Material in Animal Feed,” filed Jan. 29, 2021, which is herein incorporated by reference in its entirety for all purposes.

### TECHNICAL FIELD

The present disclosed inventive concept relates to immune and metabolic processes in animals and humans. More particularly, the disclosed inventive concept relates to a natural feed compound derived from fresh water algal cultures and to a method of using the compound that, when compared with animal or human subjects not receiving the compound, causes tissue in the animal or human subject to mature more quickly thereby promoting more robust growth. The disclosed inventive compound additionally induces an immune stimulatory response that shifts certain organs to a more adaptive response, induces lipid metabolism in selected tissues, and induces a broad immune response when the subject is challenged by pathogens. The disclosed inventive concept has particular application in the poultry industry but may also find applications beyond poultry to other animals. The disclosed inventive concept may also be beneficial to humans.

### BACKGROUND OF THE INVENTION

The commercial animal industry is under constant economic pressure to develop methods of raising animals that maximize the growth rates of healthy animals while minimizing costs related to the feeding and care of the animals. One such industry is the poultry industry which is facing dramatic increases in demand. Poultry meat competes with pork as the world's most consumed meat. It is expected that world poultry production will need to meet an increase in demand of over 120% by the year 2050.

In response to this increasing demand for supply, poultry producers are constantly seeking ways to increase the efficiency with which birds, such as broilers, convert feed into body mass as a way of increasing profit margin by decreasing the amount of feed required to produce birds of a certain size (or to maximize the size of birds produced using a given amount of feed). For farms where diseases such as coccidiosis are a significant problem, the focus on growth performance improvement is often directed at controlling disease which adversely affects growth performance. This approach, however, does nothing to improve growth performance of healthy birds.

Improving growth performance of healthy birds may be accomplished by either (1) increasing availability of nutrients in feed (by increasing digestibility, for example), (2) altering the physiology of the birds such that they metabolize available nutrients more efficiently, or (3) by shifting energy utilization in the birds away from non-growth-related processes to growth-related metabolic pathways.

Accordingly, it is desirable to develop a practical, natural, and cost-effective compound and method of use to thereby increase growth and to support overall animal health by improving immune function, thereby making the animal more resilient to disease.

### SUMMARY OF THE INVENTION

The disclosed inventive concept provides a natural compound for use as a feed ingredient to promote animal growth. The compound of the disclosed inventive concept is combined with conventional feed for administration to animals, such as poultry. Human application is possible, as well. The compound of the disclosed inventive concept comprises one or more materials selected from an algal biomass/supernatant (including both algae and bacteria), a bacterial biomass, and isolated and purified compound(s), as well as specific active sites or structures on those compounds. The combination of the disclosed inventive compound and oral administration of liquid or dry feed or both works through unique biological pathways within, for example, in healthy birds to enhance growth performance while also priming the immune system (as disclosed in U.S. Provisional Patent Application No. 63/044,841 titled “Immune Priming to Accelerate/Enhance Immune Response Through Administration of Natural Immune Modulator” and in U.S. Provisional Patent Application No. 63/056,993 titled “Natural Feed Composition Derived from Fresh Water Algal Cultures for the Promotion of Animal Growth,” both provisional patent applications incorporated by reference herein) to expedite response to a disease challenge should one arise. The disclosed inventive compound is a natural product and thus has no adverse environmental impact.

During the period of use, the compound is administered to the animal by way of poultry feed, drinking water, or both along with a nutritionally adequate or standard diet which may include, but not be limited to, a corn-soy based diet. Studies based on the use of animal feed stock including the disclosed inventive compound or biomass comprising an algal culture revealed improved growth in animals. It was found that the animals, particularly healthy birds, benefited significantly in terms of improved growth efficiency when fed the biomass of the disclosed inventive compound mixed with a conventional diet, such as a corn-soy diet. Data indicate that feeding healthy chickens (specifically, broiler chickens) a corn/soy diet supplemented with biomass, the inventive compound of algal culture, improves growth efficiency while simultaneously improving immune response compared to birds fed the same diet without algal culture biomass supplementation. It should be understood that while reference herein is made to a conventional diet of corn and soy, the disclosed compound may also be used to advantage in combination with other forms of conventional animal feed, such as, but not limited to, wheat.

Kinomic analysis of tissues collected from sacrificed birds fed the dietary mixture of the inventive compound and conventional feed suggests that the biomass causes an alteration of signaling in multiple growth-related pathways. These pathways include, but are not limited to, those associated with the vascular endothelial growth factor (VEGF), the mitogen-activated protein kinase (MAPK or MAP kinase), Ak strain transforming (Akt), and the neurotrophic tropomyosin-related kinase (NTRK). Evidence supports the conclusion that this alteration represents modulation (including but not limited to activation and deactivation) of the various pathways.

The disclosed inventive concept has numerous advantageous applications in humans and animals including but not limited to: (1) improving growth rate without the use of further supplements such as antibiotics, enzymes, probiotics, antimicrobials, ionophores and/or other chemicals, (2) providing an all-natural solution to the need for improved growth rate, and (3) improving immunity to disease.

### DESCRIPTION OF THE DRAWINGS

The patent or application contains at least one drawing executed in color. Copies of this patent or patent application publication with color drawing(s) will be provided by the Office upon request and payment of the necessary fee.

For a more complete understanding of this invention, reference should now be made to the accompanying figures in which:

FIG. 1 is a heatmap of liver and muscle tissue kinotypes;

FIG. 2 is a dendrogram of liver and muscle tissue (T2 vs T1);

FIG. 3 is a heatmap of small intestine and ceca kinotypes;

FIG. 4 is a dendrogram of small intestine and ceca tissue (T2 vs T1);

FIG. 5A is pathway diagram illustrating novel metabolism reactome pathway members in the small intestine at D14;

FIG. 5B is pathway diagram illustrating novel metabolism reactome pathway members in the small intestine at D42;

FIG. 6A is pathway diagram illustrating novel metabolism reactome pathway members in the liver at D14;

FIG. 6B is a pathway diagram illustrating novel metabolism reactome pathway members in the Liver at D42;

FIG. 7A is a pathway diagram illustrating novel metabolism reactome pathway members in the muscle at D14;

FIG. 7B is a pathway diagram illustrating novel metabolism reactome pathway members in the muscle at D42;

FIG. 8 is a pathway diagram illustrating novel metabolism reactome pathway members in the ceca;

FIG. 9A is a pathway diagram illustrating novel innate immune system reactome pathway members in the small intestine at D14;

FIG. 9B is a pathway diagram illustrating novel innate immune system reactome pathway members in the small intestine at D42;

FIG. 10A is a pathway diagram illustrating novel innate immune system reactome pathway members in the liver at D14;

FIG. 10B is a pathway diagram illustrating novel innate immune system reactome pathway members in the liver at D42;

FIG. 11A is pathway diagram illustrating novel innate immune system reactome pathway members in the muscle at D14;

FIG. 11B is pathway diagram illustrating novel innate immune system reactome pathway members in the muscle at D42; and

FIG. 12 is pathway diagram illustrating novel innate immune system reactome pathway members in the ceca.

### DETAILED DESCRIPTION OF THE PREFERRED EMBODIMENT

In the following description, various operating parameters and components are described for different constructed embodiments. These specific parameters and components are included as examples and are not meant to be limiting. Unless otherwise noted, all technical and scientific terms used herein are to be accorded their common meanings as would be understood by one having ordinary skill in the art.

The method of the disclosed inventive concept proposes the use of a compound comprising an algal biomass as well as related materials including, for example, algal supernatant, symbiont bacteria, bacterial biomass, and bacterial fermentate. The inventive compound is combined with conventional feed to create a feed mixture that is fed to chickens, for example, broiler chickens, as well as other animals, to improve growth efficiency of the birds.

The Compound Used in Growth Promotion

The disclosed growth promotion method utilizes an effective compound comprising an algal biomass and related materials. By administering the compound early in broiler life, optimal growth rate and improved immune response may be achieved. The effective compound may be derived from a lipopolysaccharide (LPS) of a gram-negative bacteria or may be derived from a source other than a lipopolysaccharide.

As used herein, the term “inhibitor” refers to a molecule that reduces or attenuates the activity induced by another molecule. By way of example, a compound that might block the LPS-dependent modulation of TLR receptors (including, but not limited to TLR2, TLR3, TLR4, TLR6, TLR7, TLR8, and/or TLR9 receptors) present on the surface of immune cells in humans and animals would be regarded as an inhibitor of this particular pathway.

As used herein, the term “algal culture” is defined as an algal organism and bacteria (one or more types) that grow together in a liquid medium. Unless expressly stated otherwise, the term “algal biomass” refers to the algal cells and bacterial cells (with the liquid culture medium removed). The “algal biomass” can be wet material or dried material.

Unless expressly stated otherwise, the term “algal supernatant” is defined as the culture medium in which the algal biomass is grown that contains excreted compounds from the algal biomass. Algal supernatant is obtained by growing algal biomass in culture medium for an appropriate length of time and then removing the algal and bacterial cells by filtration and/or centrifugation.

Embodiments of the compound used in the growth promotion method as set forth herein include one or more LPS/Lipid A compounds (which may include but not be limited to fractions, derivatives, and cellular components thereof) produced by gram-negative bacterial strains for use as selective modulators of one or more of the TLR signaling pathways. The bacterial strains include one or more of the following: Algoriphaqus aquaticus, Bosea sp., Brevundimonas diminuta, Brevundimonas vesicularis, Desulfovibrio sp., Microbacterium testaceum, Sphingomonas sp., Variovorax paradoxus, and Ochrobactrum pseudogrignonense.

The disclosed inventive concept involves any combination of three fundamental steps: (1) the gram-negative bacteria produces LPS/Lipid A compounds; (2) the LPS/Lipid compounds modulate TLR pathways; and (3) a downstream effect results in enhanced innate and adaptive immune processes, thereby preventing or reversing growth inhibition.

In an embodiment, the LPS/Lipid A compounds used as selective modulators of the TLR signaling pathway (including, but not limited to TLR 2, TLR3, TLR4, TLR6, TLR7, TLR8, and/or TLR9 receptors) are produced from one or more strains of gram-negative bacteria from Algoriphaqus aquaticus, Bosea sp., Brevundimonas diminuta, Brevundimonas vesicularis, Desulfovibrio sp., Microbacterium testaceum, Sphingomonas sp., Variovorax paradoxus, and Ochrobactrum pseudogrignonense. The strains may be naturally occurring and may be found in an algal biomass and/or algal supernatant products. For example, the algal biomass may comprise the green algal species Klebsormidium flaccidum. More specifically, the algal biomass culture may comprise the algal strain Klebsormidium flaccidum, var. ZIVO.

In another embodiment and more particularly, the LPS/Lipid A compounds used as selective modulators of the TLR signaling pathway are produced from a Rhodobacter sphaeroides strain. Extensive studies have been undertaken generally regarding the structure and function of Rhodobacter sphaeroides. More focused studies have examined the photosynthetic characteristics of Rhodobacter sphaeroides. While it is known that lipopolysaccharides from Rhodobacter sphaeroides are effective TLR4 antagonists in human cells, which prevent TLR4-mediated inflammation by means of blocking LPS/TLR4 signaling, the inventors had uncovered an LPS compound derived from Rhodobacter sphaeroides that proved effective at reversing factors causing growth inhibition. More particularly, while initial data suggested inhibition by an LPS-like molecule, it was not until specific testing directed toward Rhodobacter sphaeroides revealed the effectiveness of this bacteria in preventing or reversing growth inhibition poultry. Research further showed that combining a TLR4 modulator with an activator of TLR2 (such as LPS from many gram-negative bacteria) provides an anti-coccidiosis effect.

In yet another example, the LPS/Lipid A compound may modulate TLR4 through either ligand-dependent or ligand-independent activation. In another example, the LPS/Lipid A compound may act in concert with other TLR agonists to provide a heightened immune response, while reducing the metabolic costs to the host.

Accordingly, embodiments of the compound used according to the present disclosure are directed to one or more LPS/Lipid A compounds produced by a gram-negative bacterial strain for use as selective modulators of one or more TLR signaling pathways.

The LPS/Lipid A compound employed herein may be obtained from the gram-negative bacterial strain by any suitable method, but in specific embodiments they are extracted using standard multi-step LPS extraction protocols, such as: (1) extracting freeze-dried bacteria with a solution of phenol/guanidine thiocyanate and collecting the water layer for freeze-drying; (2) resolubilizing the freeze-dried fraction in water; (3) ultrafiltration of the solubilized fraction to remove low molecular weight substances and salts; (4) affinity purifying the high-molecular weight fraction using a polymyxin B resin column such as Affi-prep polymyxin matrix material (Bio-Rad), from which an active fraction is eluted with 1% deoxycholate and, optionally; (5) performing additional purification using size-exclusion chromatography.

In some examples, multiple types of LPS extraction protocols are employed to obtain an LPS compound from the bacteria, and extraction procedures may be performed more than once. Once the LPS compound is extracted and purified from the bacteria, the Lipid A fraction may be prepared by acid hydrolysis or other suitable technique.

The one or more LPS/Lipid A compounds derived from gram-negative bacterial strain may selectively inhibit one or more TLR signaling pathways to reduce and/or inhibit inflammatory responses and to improve immune health in a variety of uses and applications. In an embodiment, the LPS/Lipid A compound derived from one or more of the gram-negative bacterial strains referenced herein may be incorporated within an algal-based feed ingredient to increase growth while simultaneously inducing an improved immune response.

Growth Promotion Compound and Method of Use

A non-limiting example of a method for promoting animal growth is set forth. It is to be understood that while the following method is directed to the enhancement of growth in poultry, the disclosed method may apply as well to other animals as well as humans. Accordingly, the described growth promotion compound and method of use is not intended as being solely for use in poultry.

Earlier undertakings by the Applicant herein demonstrated several beneficial effects of the inventive algae-based compound disclosed herein fed to poultry. However, further data on the specific mechanism of action, especially at a protein, post-translational and cellular signaling level was required. The present invention provides an analysis that characterizes immune and metabolic responses resulting from feeding the inventive algae compound together with a corn-soy based diet compared to a control corn-soy diet alone. Specific objectives accomplished in this study and discussed herein included determining immune and metabolic changes in the small intestine (specifically, Meckel's diverticulum adjacent), liver, ceca and breast muscle induced by the addition of the inventive algae product to the corn-soy diet of broiler chickens.

### Example

According to the present, non-limiting example, the inventive compound is defined as the algal biomass as set forth above and related materials including algal supernatant and symbiont bacteria. The inventive compound was mixed with conventional feed to form a supplemented “feed mixture” at a fixed ratio. This ratio was maintained throughout the test period. The bird flock was divided into a control group fed only conventional corn-soy feed and an experimental group fed the supplemented feed mixture. The inventive compound was orally administered via dry or liquid feed to the animals in their early life stages defined as being sometime during the first and second weeks of life.

Two growth-promoting treatment regimens were administered:

Treatment 1 (T1)=corn-soy diet control
Treatment 2 (T2)=corn-soy diet+algae

The growth-promoting compound according to the present disclosed inventive concept was tested at a research university in a 42-day broiler pen study. Overall, the results showed that after Day 14 of life, birds fed a feed composition including the disclosed inventive compound and a corn/soy mixture demonstrated improved metabolism and improved immune response compared to control animals fed only the corn/soy mixture. An on-going review of small segments of numerous other studies in which healthy birds were fed a composition containing the inventive compound for a limited time before a disease challenge was applied preliminarily suggests positive effects of the inventive compound in healthy animals when combined with convention animal feed.

The treatment compound is fresh water algal biomass containing one or more of the Gram-negative bacteria Algoriphaqus aquaticus, Bosea sp., Brevundimonas diminuta, Brevundimonas vesicularis, Desulfovibrio sp., Microbacterium testaceum, Sphingomonas sp., Variovorax paradoxus, and Ochrobactrum pseudogrignonense or compounds derived therefrom, provided in drinking water or as animal feed in combination of a feed additive, such as soy oil, preferably though not exclusively at a ratio of two parts soy oil to one part algal biomass. In animal feed, once the biomass and feed additive are combined to the preferred premix level, the combined batch is poured or administered evenly into a ribbon mixer containing finished feed. When including the disclosed inventive concept as algal biomass in animal feed, the combined batch is preferably provided in an amount of between about 0.5 lbs. composition per ton of finished feed to about 11.0 lbs. composition per ton of finished feed, is more preferably provided in an amount of between about 1.0 lbs. composition per ton of finished feed to about 5.0 lbs. composition per ton of finished feed, and is most preferably provided in an amount of between about 3.0 lbs. composition per ton of finished feed to about 4.0 lbs. composition per ton of finished feed. The ideal suggested and non-limiting ratio is about 3.5 lbs. composition per ton of finished feed with good efficacy without being wasteful.

When including the disclosed inventive concept as bacterial biomass in animal feed, the combined batch is preferably provided in an amount of between about 20.0 g composition to ton of finished feed to about 250.0 g composition to ton of finished feed, is more preferably provided in an amount of between about 125.0 g composition to ton finished feed to about 175.0 g composition to ton of finished feed, and is most preferably provided in an amount of between about 100.0 g composition per ton of finished feed to about 150.0 g composition per ton of finished feed. The ideal suggested and non-limiting ratio is about 125.0 g composition per ton of finished feed for maximum effect.

Study—Treatment Method

Mixed sex broiler chicks were obtained from a commercial hatchery on Day 0 (hatch and placement day). Chicks were evaluated upon receipt for signs of disease or other complications that could affect study outcome. Weak birds were humanely sacrificed. Birds were not replaced during the study.

Following examination, chicks were weighed and allocated to pens for the various treatment groups using a randomized block design. Weight distribution across the treatment groups was assessed prior to feeding by comparing the individual test groups' standard deviations of the mean against that of the control group. Weight distribution across the groups was considered acceptable for this study when differences between control and test groups were within one standard deviation.

All birds received nutritionally adequate diets. Pens were monitored for environmental conditions, including temperature, lighting, water, feed, litter condition, and unanticipated house conditions/events. Pens were checked daily for mortality. Examinations were performed on all broilers found dead or moribund. Mortalities were recorded and examined.

After completion of the growth period, muscle, liver, small intestine, and ceca tissue were collected from five birds from each of the two diet groups at days 14 (D14) and 42 (D42) post hatch. Tissue samples were removed from chickens and immediately flash frozen in liquid nitrogen to preserve kinase enzymatic activity. Samples were kept on dry ice and stored at −80° C. until the experimental protocol was conducted. Tissue samples were thawed, and a 40 mg section was collected and placed in 2.0 mL homogenizer tubes containing 1.5 mm Zirconium beads and 100 uL of lysis buffer. Samples were homogenized in a Bead Ruptor.

Homogenized tissue was then incubated on ice for 10 min then spun in a microcentrifuge. Peptide array production was then undertaken generating 771 unique kinase substrate target peptide sequences printed in replicate nine times.

A glass lifter slip was applied to the microarray to sandwich and disperse the applied lysate. Eighty μL of the mixture were applied to the peptide microarray, ensuring that no bubbles were present in the pipette tip or array slide. Slides were incubated for 2 h in a humidity chamber: a sealed container containing a small amount of water (not in contact with the arrays) within an incubator. Arrays were removed from the incubator and humidity chamber and placed in a centrifuge tube containing phosphate-buffered saline. The arrays were submerged in a solution repeatedly until the lifter slip slid off the array. Arrays were then submerged and agitated. This process was then repeated with fresh solution. Arrays were submerged in ddH20 and agitated. Array slides were removed from the ddH20 and submerged in phospho-specific fluorescent stain in a dish and placed on a shaker table. The dish was covered to protect the fluorescent stain from light. Arrays were then placed in a new dish and submerged in destaining solution with agitation. The petri dish was covered to protect the stain from light. This process was repeated two times. A final wash was done with distilled deionized H2O.

Arrays were then placed in mL centrifuge tubes with a crumpled Kimwipes in the bottom. The tubes containing the arrays were then centrifuged to remove any moisture from the array. Arrays were scanned using a Tecan PowerScanner microarray scanner at 532 to 560 nm with a 580-nm filter to detect dye fluorescence.

Statistical and Data Analysis

Images were generated and the spot intensity signal was collected as the mean of pixel intensity using local feature background intensity calculation with the default scanner saturation level.

Images were gridded and the spot intensity signal was collected as the mean of pixel intensity using local feature background intensity calculation with the default scanner saturation level. The resultant data were then analyzed by PIIKA2 peptide array analysis software. Briefly, the resulting data points were normalized to eliminate variance due to technical variation, e.g., random variation in staining intensity between arrays or between array blocks within an array. Variance stabilization normalization was performed. It should be noted that as the arrays were printed with triplicate peptide blocks, there were three values for each peptide. Using the normalized data set, comparisons between growth-promoting treatment and control groups were performed, calculating fold change and a significance P-value. The P-value was calculated by conducting a one-sided paired t test between growth-promoting treatment and negative control values for a given peptide. The resultant fold change and significance values were then used to generate optional analysis (including heatmaps, hierarchical clustering, principal component analysis, and pathway analysis).

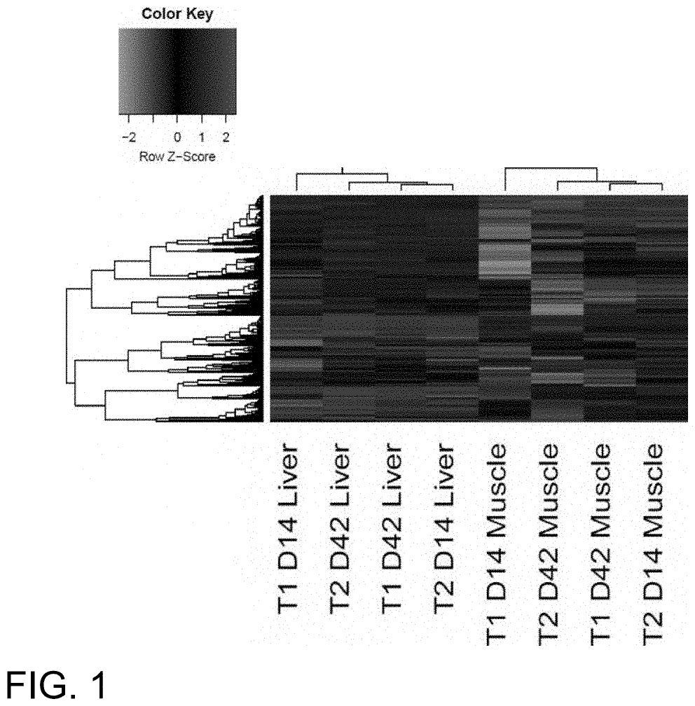

The four tissues analyzed by chicken-specific kinome peptide arrays (small intestine, liver, muscle, ceca) were run through the analysis pipeline, Platform for Integrated, Intelligent Kinome Analysis 2 (PIIKA2) in two batches, liver and muscle in one and ceca and small intestine (area surrounding the Meckel's diverticulum) in the other. The heatmap of the liver and muscle kinome signal is shown in FIG. 1. Each column in the figure represents the total phosphorylation signal of the tissue from the array. This is referred to as the kinome profile or kinotype of the tissue. The connecting lines at the top of the figure represent the clustering, or relative similarity of kinotypes between each tissue. There is a strong similarity between samples of the same tissue regardless of treatment or age of birds. This is reflected in the two distinct clusters in FIG. 1, one for liver and one for muscle. This similarity is to be expected as muscle and liver are very physiologically and functionally distinct and would be expected to display distinct kinome profiles. Within each tissue cluster, the D14 T1 samples cluster separately from the other groups. This indicates that the effect of the algae addition to the diet was to make the D14 tissue look more similar to D42 tissue overall.

FIG. 1 illustrates a heatmap of liver and muscle tissue kinotypes post PIIKA2 analysis. Each colored line within each column represents a peptide on the array. Red indicates relative increase in phosphorylation, green is relative decrease. General kinotype clustering displays predominantly tissue specific clustering.

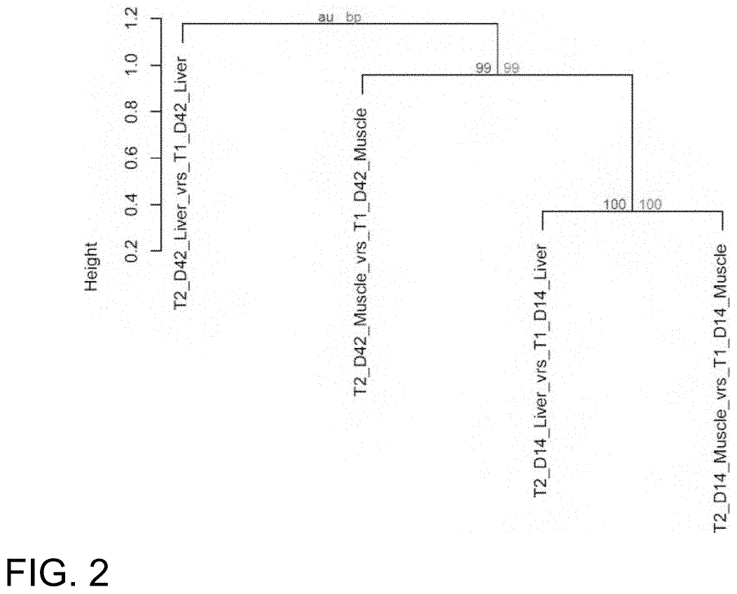

When the growth-promoting treatment is compared to the control (T2 vs T1) pairs for each time-matched tissue, the signal is eliminated that was not due to the addition of the algae to the diet. This generates a fold change increase or decrease in phosphorylation relative to control for each peptide (fold change peptide X=T2 peptide X/T1 peptide X). This data was then clustered for relative similarity. It was found that the liver and muscle tissues at D14 were most similar (FIG. 2). This indicates that the algae product is having a similar signaling effect on both tissues at D14 and possibly that effect was strongest at this early time point.

FIG. 2 illustrates a dendrogram of liver and muscle tissue (T2 vs T1) showing a clustering of the kinotypes following calculation of fold change. By removing the control corn-soy diet and tissue related responses from the kinotypes it may be seen that the augmented diet brings the two tissues into closer alignment based on growth-promoting treatment and age at D14.

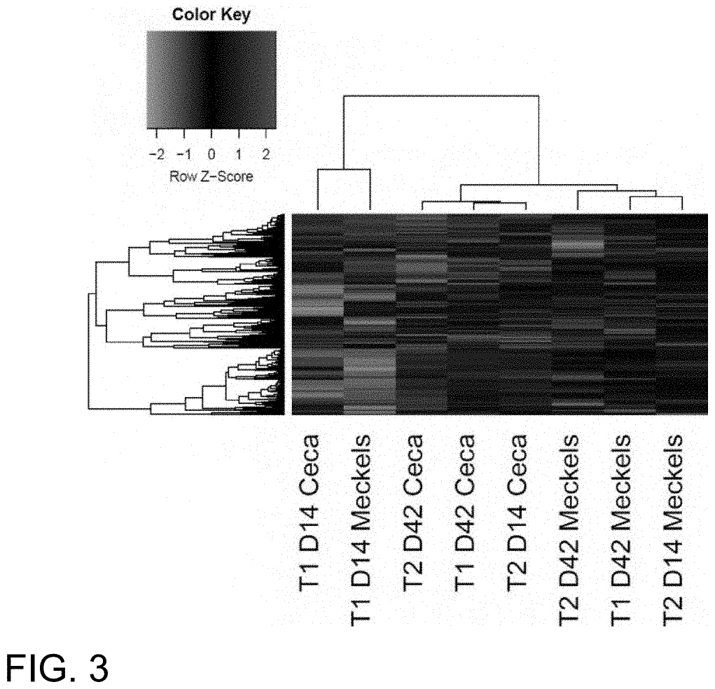

When the tissues of the gut are considered, specifically the small intestine (surrounding the Meckel's) and the ceca (FIG. 3), a pattern similar to that of FIG. 1 may be seen. There is a strong similarity between samples of the same tissue regardless of treatment or age of birds. This similarity is to be expected as the small intestine and the ceca are also physiologically and functionally distinct and would be expected to display distinct kinome profiles. However, unlike with the liver and muscle the T1 D14 small intestine and ceca samples cluster together outside of their respective tissue clusters. This indicates that the effect of the algae addition to the diet was to make the D14 tissue look more similar to D42 tissue overall. The clustering pattern is even more striking in FIG. 3 than FIG. 1 as the T1 D14 tissues actually cluster completely apart from the other samples, though there were significant differences between the two as shown by the length of the lines connecting the two columns.

FIG. 3 illustrates a heatmap of small intestine and ceca kinotypes post PIIKA2 analysis. Each colored line within each column represents a peptide on the array. Red indicates relative increase in phosphorylation, green is relative decrease. General kinotype clustering shows tissue-based clustering with the exception of D14 T1 groups.

As mentioned above, when the growth-promoting treatment is compared to the control (T2 vs T1) signal that was not due to the addition of the algae to the diet may be eliminated. This data was then clustered for relative similarity. It was found that the small intestine and ceca tissues at D14 were most that the algae product is having a similar signaling effect on both tissues at D14 and possibly that effect is strongest at the early time point.

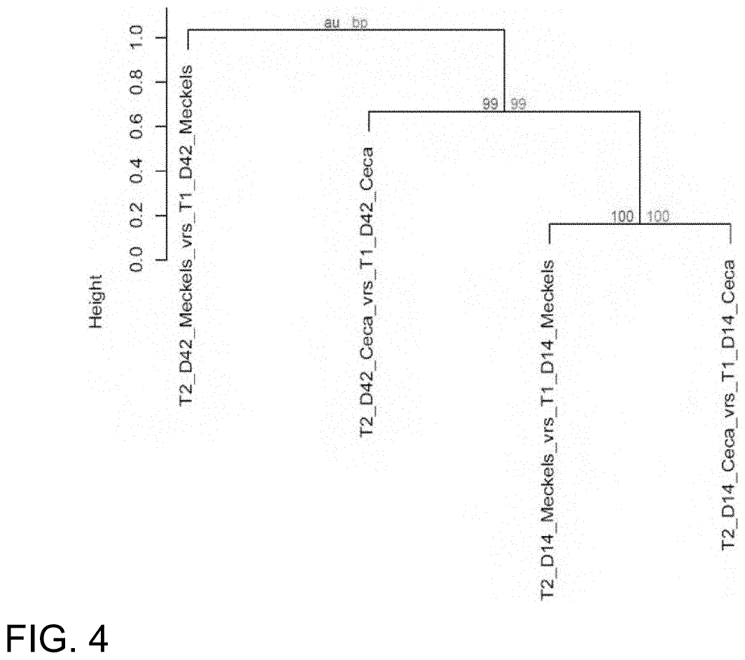

FIG. 4 illustrates a dendrogram of small intestine and ceca tissue (T2 vs T1) demonstrating a clustering the kinotypes following calculation of fold change. By removing the control corn-soy diet and tissue related responses from the kinotypes it can be seen that the augmented diet brings the two tissues into closer alignment based on growth-promoting treatment and age at D14.

Based on the above data from the four tissues, it appears that the strongest impact of the algae supplementation to the diet occurs at D14. This was especially true in the gut tissue as the product appears to make a D14 gut look more like a D42 gut, regardless of if the D42 gut received supplement or not (FIG. 3). When comparing treatment to time matched control, and only considering the effect of the algae, the pattern of signaling changes is consistent between the tissue pairs in the small intestine and ceca, and liver and muscle. FIGS. 2 and 4 show that the D14 samples cluster together, separately from the D42 samples. The above data shows evidence that the algae product was maturing the tissue at D14, causing its kinome profile to appear similar to a mature tissue at D42.

By analyzing what protein changes were occurring at D14 compared to D42, the kinome changes behind this clustering pattern may be understood. The proteins that displayed statistically significant differences between algae treatment and control for each tissue and each time point were input into the STRING database to generate signaling pathways. (The “STRING” database as used herein refers to “Search Tool for the Retrieval of Interacting Genes/Proteins,” a biological database and web resource of known and predictable protein-protein interactions taken from several sources including computational prediction methods, public text collections, and experimental data.) This data can then be analyzed to determine changes in biological function resulting from the algae.

In the following tables:

“Proteins” references the number of proteins within the pathway differentially phosphorylated on the array, while “Background” is the number of proteins within the pathway, and “FDR” is false discovery rate significance value of the pathway.

“Reactome” refers to an open-source, open access, manually curated and peer-reviewed pathway database used in support of basic and clinical research related to genome analysis and modeling.

“MYD88” refers to the first known downstream component of TLR4 and TLR2 signaling.

“TRIF(TICAM1)-mediated TLR4 signaling” or “Toll-Like Receptor Adaptor Molecule 1” refers to a protein coding gene. The activated TLR4 signaling pathway is related to TICAM1.

“Fc Epsilon Receptor (FCER1)” refers to the high-affinity IgE receptor for the Fc region of immunoglobulin E (IgE). It is also as FcεRI or Fc epsilon RI.

Table 1 A and B shows the top 20 pathways in the small intestine tissue that were changed by the addition of algae to the diet at D14 in Table 1 A) D14 and Table 1 B) D42. Highlighted in bold script are the pathways that were unique to the specific day.

At D42 with the algae supplement there was an increase in the adaptive immune response (Table 1 B), perhaps indicating a more immunologically competent, or developed, system by this time. It is possible that the supplement primed the immune system, starting with the innate system. This resulted in a more adaptive biased immune system in the supplemented birds by D42. Evidence for this includes the adaptive immune system pathway at D42 in the supplemented birds as well as the substantial changes in TLR signaling at D14.

TABLE 1 A
D14

| | Pro- | Back- | |
|---|---|---|---|
| Reactome Pathway | teins | ground | FDR |
| Immune System | 122 | 1925 | 6.05E−35 |
| Signaling by Receptor Tyrosine Kinases | 136 | 2605 | 1.88E−32 |
| Signal Transduction | 84 | 1012 | 7.99E−31 |
| Signaling by Interleukins | 68 | 654 | 9.75E−30 |
| Innate Immune System | 56 | 437 | 2.77E−28 |
| Disease | 56 | 439 | 2.86E−28 |
| Cytokine Signaling in Immune System | 35 | 151 | 1.15E−24 |
| Disease of signal transduction | 47 | 360 | 6.48E−24 |
| Disease | 71 | 1018 | 1.04E−21 |
| Toll-like Receptor 4 (TLR4) Cascade | 30 | 126 | 2.06E−21 |
| MAPK family signaling cascades | 37 | 273 | 3.74E−19 |
| MyD88:MAL(TIRAP) cascade initiated on | 25 | 94 | 9.173−19 |
| plasma membrane | | | |
| Toll-like Receptor 3 (TLR3) Cascade | 25 | 95 | 9.78E−19 |
| Toll-like Receptor 4 (TLR4) Cascade | 25 | 96 | 1.08E−18 |
| TRIF (TICAM1)-mediated TLR4 signaling | 25 | 96 | 1.08E−18 |
| MyD88 cascade initiated on plasma | 24 | 84 | 1.08E−18 |
| membrane | | | |
| Intracellular signaling by second messengers | 36 | 274 | 1.59E−18 |
| TAF6 mediated induction of NFkB and MAP | 24 | 91 | 3.283−18 |
| kinases upon TLR | | | |
| P13K/AKT Signaling in Cancer | 23 | 85 | 1.07E−17 |
| Fc epsilon receptor (FCERI) signaling | 26 | 126 | 1.56E−17 |

TABLE 1 B
D42

| | Pro- | Back- | |
|---|---|---|---|
| Reactome Pathway | teins | ground | FDR |
| Immune System | 115 | 1925 | 6.05E−35 |
| Signaling by Receptor Tyrosine Kinases | 58 | 437 | 8.58E−32 |
| Signal Transduction | 126 | 2605 | 1.13E−30 |
| Signaling by Interleukins | 53 | 439 | 2.93E−27 |
| Innate Immune System | 75 | 1012 | 6.87E27 |
| Disease | 73 | 1018 | 2.56E−25 |
| Cytokine Signaling in Immune System | 59 | 654 | 1.06E−24 |
| Diseases of signal transduction | 43 | 360 | 7.70E−22 |
| Intracellular signaling by second messengers | 37 | 274 | 2.76E−20 |
| Signaling by VEGF | 25 | 104 | 1.17E−18 |
| VEGFA-VEGFR2 Pathway | 24 | 95 | 2.39E−18 |
| Signaling by NRKs | 24 | 97 | 3.32E−18 |
| Axon guidance | 46 | 541 | 4.10E−18 |
| MAPK family signaling cascades | 33 | 273 | 7.93E−17 |
| Signaling by NTRK1 (TRKA) | 21 | 76 | 9.14E−17 |
| PIP3 activates AKT signaling | 31 | 242 | 1.76E−16 |
| Toll-like Receptor Cascades | 26 | 151 | 1.76E−16 |
| Adaptive Immune System | 49 | 733 | 1.74E−15 |
| FC epsilon receptor (FCERI) signaling | 23 | 126 | 4.58E−15 |
| Developmental Biology | 57 | 1023 | 6.71E−15 |

Tables 1A and 1B: Small intestine (Meckel's adjacent) Reactome Pathways. Statistically significantly differentially phosphorylated proteins from the small intestine at D14 and D42 were input into the STRING database to generate a list of enriched reactome pathways. Table 1 A) D14 shows the top 20 pathways from D14, Table 1 B) D42 shows the top twenty pathways from D42. Highlighted in bold script are the unique pathways from each time point. Much of the unique signaling at D14 is related to innate immune signaling, while the signaling at D42 is related to growth and the adaptive immune system. “Proteins” is the number of proteins within the pathway differentially phosphorylated on the array, “Background” is the number of proteins within the pathway, and “FDR” is false discovery rate significance value of the pathway.

The same analysis as above, run on the liver samples shows that there were few unique signaling pathways between D14 and D42 (Table 2 A and B). Those that were unique were related to growth: “Signaling by VEGF” at D14 and “MAPK family signaling cascades at D42.” Of the differences between the two time points of particular interest was that there were two innate immune signaling pathways related to TLR signaling in the top twenty list at D14 that were not present at D42. That does not mean that there was no innate immune signaling or TLR signaling at D42. Instead, this means that there was additional unique TLR signaling at D14. This may again point to a more robust immune stimulation by the algae early in grow out, possibly maturing the tissue at this early point.

TABLE 2 A
D14

| | Pro- | Back- | |
|---|---|---|---|
| Reactome Pathway | teins | ground | FDR |
| Immune System | 152 | 1925 | 4.53E−24 |
| Signaling by Receptor Tyrosine Kinases | 78 | 437 | 4.69E−44 |
| Signal Transduction | 168 | 2605 | 1.91E−43 |
| Cytokine Signaling by Immune system | 84 | 654 | 3.60E−38 |
| Innate Immune System | 101 | 1012 | 5.56E−38 |
| Signaling by Interleukins | 71 | 439 | 102E−37 |
| Disease | 94 | 1018 | 1.22E−32 |
| Disease of signal transduction | 60 | 360 | 3.12E−32 |
| Toll-like Receptor Cascades | 40 | 151 | 1.34E−27 |
| Intracellular signaling by second messengers | 46 | 274 | 1.7E−24 |
| Toll-like Receptor 4 (TLR4) Cascade | 34 | 126 | 1.25E−23 |
| Signaling by VEGF | 32 | 104 | 1.25E−23 |
| VEGFA-VEGFR2 Pathway | 31 | 95 | 1.42E−23 |
| Signaling by NTRKs | 31 | 97 | 2.23E−23 |
| Signaling by NTRK1 (TRKA) | 28 | 76 | 1.86E−22 |
| Toll-like Receptor 9 (TLR9) Cascade | 30 | 96 | 2.03E−22 |
| PIP3 activates AKT signaling | 41 | 242 | 4.643−22 |
| TRAF6 mediated induction of NFkB | 29 | 91 | 6.76E−22 |
| and MAPk | | | |
| MyD88:MAL(TIRAP) cascade initiated | 29 | 94 | 1.24E−21 |
| on plasma membrane | | | |
| PI3I/AKT Signaling in Cancer | 28 | 85 | 1.50E−21 |

TABLE 2 B
D42

| | Pro- | Back- | |
|---|---|---|---|
| Reactome Pathway | teins | ground | FDR |
| Signaling by Receptor Tyrosine Kinases | 63 | 437 | 6.25E−41 |
| Signal Transduction | 124 | 2605 | 9.10E−28 |
| Immune System | 102 | 1925 | 3.39E−33 |
| Diseases of signal transduction | 48 | 360 | 1.77E−29 |
| Signaling by Interleukins | 50 | 439 | 5.51E−28 |
| Disease | 69 | 1018 | 7.42E−27 |
| Intracellular signaling by second messenger | 41 | 274 | 7.62E−27 |
| Cytokine Signaling in Immune System | 56 | 654 | 5.24E−26 |
| Innate Immune System | 67 | 1012 | 1.39E−25 |
| VEGFA-VEGFR2 Pathway | 28 | 95 | 5.17E−25 |
| PIP3 activates AKT signaling | 36 | 242 | 1.62E−23 |
| PI3K/AKT Signaling in Cancer | 25 | 85 | 2.583−22 |
| Signaling by NTRKs | 25 | 97 | 3.81E−21 |
| Signaling by NTRK1 (TRKA) | 23 | 76 | 9.28E−21 |
| Negative regulation of the PI3K/AKT | 24 | 92 | 1.98E−20 |
| network | | | |
| Toll-like Receptor Cascades | 27 | 151 | 2.36E−19 |
| MAPK family signaling cascades | 33 | 273 | 4.31E−19 |
| Toll-like Receptor 4 (TLR4) Cascade | 25 | 126 | 7.14E−19 |
| TRAF6 mediated induction of NFkB | 22 | 91 | 3.76E−18 |
| Axon guidance | 42 | 541 | 5.95E−18 |

Tables 2A and 2B: Liver Reactome Pathways. Statistically significantly differentially phosphorylated proteins from the liver at D14 and D42 were input into the STRING database to generate a list of enriched reactome pathways. Table 2 A) D14 shows the top twenty pathways from D14, Table 2 B) D42 shows the top twenty pathways from D42. Highlighted in bold script are the unique pathways from each time point. Unique to D14 (Table 2 A) D14) is a mix of growth and innate immune signaling. In Table 2 B) D42 growth represents a unique characteristic. This may indicate priming and growth early while later the supplement enhances growth related signaling.

The differential responses in the muscle were functionally quite different between the D14 and D42 pathways (Table 3 A and B). At D42 in the muscle there was a mix of pro-growth (MAPK, AKT) signaling and innate immune signaling (TLR4 and 9) (Table 3B). At D14 there was TRAF6 mediated innate immune signaling but the other two unique pathways were related to NTRK signaling (Table 3A). NTRKs are neuronal related signaling receptors that leads to cell differentiation and MAPK related growth. There function has been shown to be associated with muscle-bone formation, cell growth and immune response to the alpha-toxin of Clostridium perfringens. These effects of the algae on the muscle have many intriguing possibilities such as improved muscle/bone development, further growth of muscle or immune priming, all found early in the muscle compared to later in grow-out.

TABLE 3 A
D14

| | Pro- | Back- | |
|---|---|---|---|
| Reactome Pathway | teins | ground | FDR |
| Signal Transduction | 130 | 2605 | 1.65E−32 |
| Immune System | 111 | 1925 | 4.34E−32 |
| Signaling by Receptor Tyrosine Kinases | 57 | 437 | 7.32E−31 |
| Innate Immune System | 78 | 1012 | 6.60E−29 |
| Diseases of signal transduction | 49 | 360 | 3.81E−27 |
| Cytokine Signaling in Immune system | 61 | 654 | 3.87E−26 |
| Signaling by Interleukins | 51 | 439 | 1.50E−25 |
| Disease | 71 | 1018 | 8.23E−24 |
| Signaling by NTRKs | 27 | 97 | 1.49E−21 |
| Toll-like Receptor Cascades | 31 | 151 | 1.60E−21 |
| Signaling by NTRK1 (TRKA) | 25 | 76 | 1.82E−21 |
| MAPK family signaling cascades | 36 | 273 | 1.94E−19 |
| TRAF6 mediated induction of NFkB | 24 | 91 | 9.58E−19 |
| and MAP kinases | | | |
| MyD88:MAL(TIRAP) cascade | 24 | 94 | 1.49E−18 |
| initiated on plasma membrane | | | |
| VEGF-VEGFR2 Pathway | 24 | 95 | 1.63E−18 |
| Toll-like Receptor 4 (TLR4) Cascade | 26 | 126 | 2.77E−18 |
| MyD88 cascade initiated on plasma | 22 | 84 | 2.48E−18 |
| membrane | | | |
| PI3KI/AKT Signaling on Cancer | 22 | 85 | 2.74E−17 |
| Intracellular signaling by second | 33 | 274 | 5.14E−17 |
| messengers | | | |
| Toll-like Receptor 3 (TLR3) Cascade | 22 | 95 | 1.96E−16 |

TABLE 3 B
D42

| | Pro- | Back- | |
|---|---|---|---|
| Reactome Pathway | teins | ground | FDR |
| Immune System | 134 | 1925 | 6.30E−46 |
| Innate Immune System | 91 | 1012 | 5.36E−37 |
| Signaling by Receptor Tyrosine Kinases | 62 | 437 | 3.31E−34 |
| Signal Transduction | 136 | 2605 | 6.38D−34 |
| Signaling by Interleukins | 58 | 439 | 1.60E−30 |
| Disease of signal transduction | 52 | 360 | 7.08E−29 |
| Cytokine Signaling in Immune system | 66 | 654 | 7.21E−29 |
| Disease | 80 | 1018 | 1.01E−28 |
| VEGFA-VEGFR2 Pathway | 28 | 95 | 2.95E−22 |
| MAPK family signaling cascades | 40 | 273 | 3.23E−22 |
| Toll-like Receptor Cascades | 32 | 151 | 7.21E−22 |
| Intracellular signaling by second | 37 | 274 | 1.78E−19 |
| messengers | | | |
| PI3KI/AKT Signaling on Cancer | 24 | 85 | 9.25E−19 |
| Toll-like Receptor 4 (TLR4) Cascade | 27 | 126 | 1.52E−18 |
| Toll-like Receptor 3 (TLR3) Cascade | 24 | 95 | 7.37E−18 |
| TRIF(TICAM1)-mediated TLR4 | 24 | 96 | 8.54E−18 |
| signaling | | | |
| MAPK1/MAPK3 signaling | 32 | 234 | 5.09E−17 |
| MyD88:MAL(TIRAP) cascade | 23 | 94 | 6.42E−17 |
| initiated on plasma membrane | | | |
| Toll-like Receptor 9 (TLR9) Cascade | 23 | 96 | 8.72E−17 |
| PIP3 activates AKT signaling | 32 | 242 | 9.27E−17 |

Tables 3A and 3B: Muscle Reactome Pathways. Statistically significantly differentially phosphorylated proteins from the muscle at D14 and D42 were input into the STRING database to generate a list of enriched reactome pathways. Table 3 A) D14 shows the top twenty pathways from D14 while Table 3 B) D42 shows the top twenty pathways from D42. Highlighted in bold script are the unique pathways from each time point. NTRK signaling is shown in the muscle at D14 in Table 3 A) D14. At D42 in Table 3 B) D42 there is a mix of immune and growth related signaling. “Proteins” is the number of proteins within the pathway differentially phosphorylated on the array, “Background” is the number of proteins within the pathway, “FDR” is false discovery rate significance value of the pathway.

In the ceca, there is a limited number of unique signaling pathways between D14 and D42. While signaling by NTRKs was unique to D14, Signaling by NTRK1 shows up at both D14 and D42, and this pathway is likely associated with simple cell growth responses, possibly immune related. Signaling by VEGF is also unique at D14 but signaling by VEGFA-VEGFR2 Pathway is present at D42 and is a subset of this larger pathway group, again related to cellular growth signals. At D42, Akt signaling and TLR signaling through MyD88 are unique and represent a mix of growth and immune signaling not present at D42. However, overall it does not appear that the algae results in significant changes between D14 and D42 in the ceca, as compared to the other tissues.

TABLE 4 A
D14

| | Pro- | Back- | |
|---|---|---|---|
| Reactome Pathway | teins | ground | FDR |
| Immune System | 154 | 1925 | 9.14E−47 |
| Signal Transduction | 176 | 2605 | 1.35E−45 |
| Signaling by Receptor Tyrosine Kinases | 75 | 437 | 5.60E−40 |
| Innate Immune System | 104 | 1012 | 1.99E−38 |
| Diseases of signal transduction | 61 | 360 | 6.74E−32 |
| Cytokine Signaling in Immune system | 7 | 654 | 6.74E−32 |
| Signaling by Interleukins | 65 | 439 | 3.53E−31 |
| Disease | 94 | 1018 | 3.53E−31 |
| Toll-like Receptor Cascades | 42 | 151 | 3.92E−31 |
| MAPK family signaling cascades | 48 | 273 | 4.96E−29 |
| Toll-like Receptor 4 (TLR4) Cascade | 35 | 126 | 1.34E−25 |
| Intracellular signaling by second | 46 | 274 | 4.63E−24 |
| messengers | | | |
| Signaling by NTRKs | 30 | 97 | 8.44E−24 |
| TRAF6 mediated induction of NFkB | 29 | 91 | 1.08E−21 |
| and MAP kinases | | | |
| Signaling by VEGF | 30 | 104 | 2.80E−21 |
| MyD88:MAL(TIRAP) cascade initiated | 29 | 94 | 4.48E−21 |
| on plasma membrane | | | |
| Toll-Like Receptor 3 (TLR3) Cascade | 29 | 95 | 4.65E−21 |
| PI3KI/AKT Signaling on Cancer | 28 | 85 | 5.35E−21 |
| VEGFA-VEGFR2 Pathway | 29 | 95 | 5.35E−21 |
| Signaling by NTRK1 (TRKA) | 27 | 76 | 5.36E−21 |

TABLE 4 B
D42

| | Pro- | Back- | |
|---|---|---|---|
| Reactome Pathway | teins | ground | FDR |
| Immune System | 113 | 1925 | 1.28E−36 |
| Signaling by Receptor Tyrosine Kinases | 60 | 43 | 1.98E−35 |
| Signal Transduction | 125 | 2605 | 2.18E−33 |
| Innate Immune System | 78 | 1012 | 3.48E−31 |
| Signaling by Interleukins | 53 | 439 | 8.52E−29 |
| Cytokine Signaling in Immune System | 62 | 654 | 8.84E−29 |
| Diseases of single transduction | 46 | 360 | 8.65E−26 |
| Intracellular signaling by second | 39 | 274 | 3.36E−23 |
| messengers | | | |
| Disease | 66 | 1018 | 3.89E−22 |
| Signaling by NRK1 (TRKA) | 24 | 76 | 6.78E−21 |
| Toll-like Receptor Cascades | 29 | 151 | 2.99E−20 |
| VEGFA-VEGFR2 Pathway | 25 | 95 | 3.05E−20 |
| PI3K/AKT Signaling in Cancer | 24 | 85 | 4.82E−20 |
| Toll-like Receptor 4 (TLR4) Cascade | 27 | 126 | 5.63E−20 |
| PIP3 activates AKT signaling | 33 | 242 | 3.37E−19 |
| MyD88 cascade initiated on plasma | 23 | 84 | 4.90E−19 |
| membrane | | | |
| MAPK family signaling cascades | 34 | 273 | 8.44E−19 |
| TRAF6 mediated induction of NFkB | 23 | 91 | 1.75E−18 |
| and MAP kinases upon TLR7/8 or 9 | | | |
| MyD88:MAL(TIRAP) cascade initiated | 23 | 94 | 2.89E−18 |
| on plasma membrane | | | |
| Toll-like Receptor 3 (TL3) Cascade | 23 | 95 | 3.29E−18 |

Tables 4A and 4B: Ceca Reactome Pathways. Statistically significantly differentially phosphorylated proteins from the ceca at D14 and D42 were input into the STRING database to generate a list of enriched reactome pathways. Table 4 A) D14 shows the top twenty pathways from D14 while Table 4 B) D42 shows the top twenty pathways from D42. Highlighted in bold script are the unique pathways from each time point. “Proteins” is the number of proteins within the pathway differentially phosphorylated on the array, “Background” is the number of proteins within the pathway, “FDR” is false discovery rate significance value of the pathway.

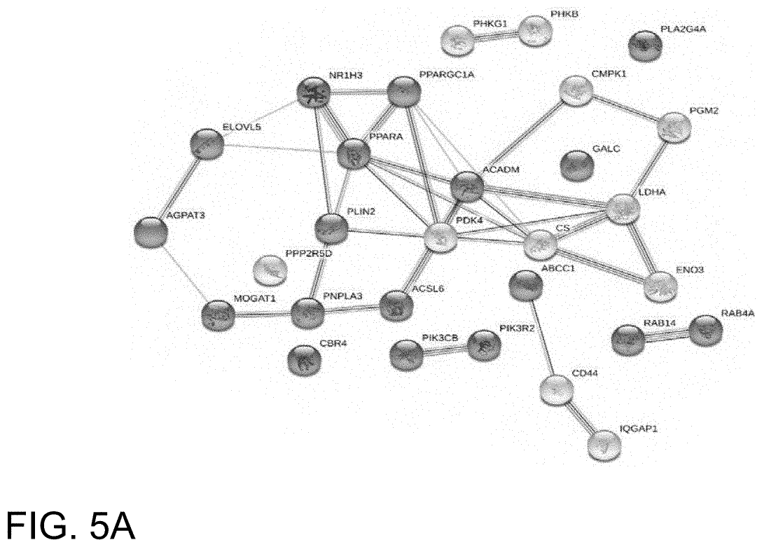

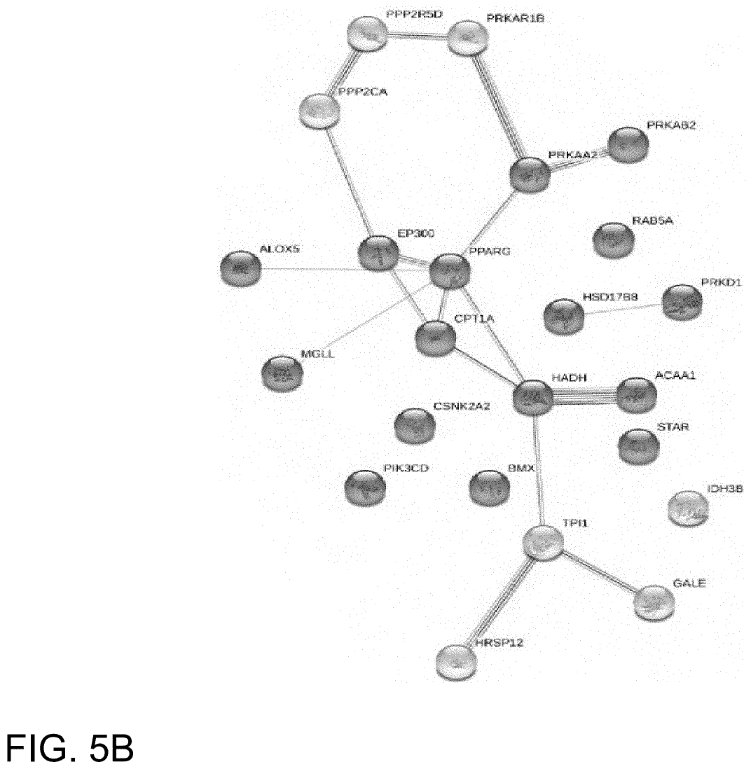

While not showing up in the top twenty of reactome pathways, in all tissues and time points there was a broad pathway called metabolism that showed significant changes between algae supplementation and the control. The significantly differentially phosphorylated proteins within the metabolism pathway were compared between D14 and D42 for each tissue. Those proteins that are unique to each time point were uploaded into STRING. Within the resulting protein interaction groups (FIGS. 5-8) there were certain macronutrient metabolic processes that were enriched. The fact that the unique proteins generated overwhelmingly contiguous protein-protein interaction networks indicates that these proteins are part of an interacting metabolic process and are not just disparate phosphorylation changes.

In the small intestine, at both D14 and D42, within the metabolism pathway, the unique protein interaction groups were enriched for “Metabolism of Lipids” (FIG. 5). Thus, despite differences in response to the algae at the two different ages of birds, a major effect was to alter the metabolism of lipids in the gut.

FIGS. 5A and 5 B illustrate novel metabolism reactome pathway members in the small intestine (Meckel's adjacent) at D14 and D42 respectively. Proteins that were unique to each time point within the metabolism reactome pathway were input into STRING to generate protein-protein interaction groups. Red proteins are members of the “Metabolism of Lipids” pathway for both D14 (A) and D42 (B).

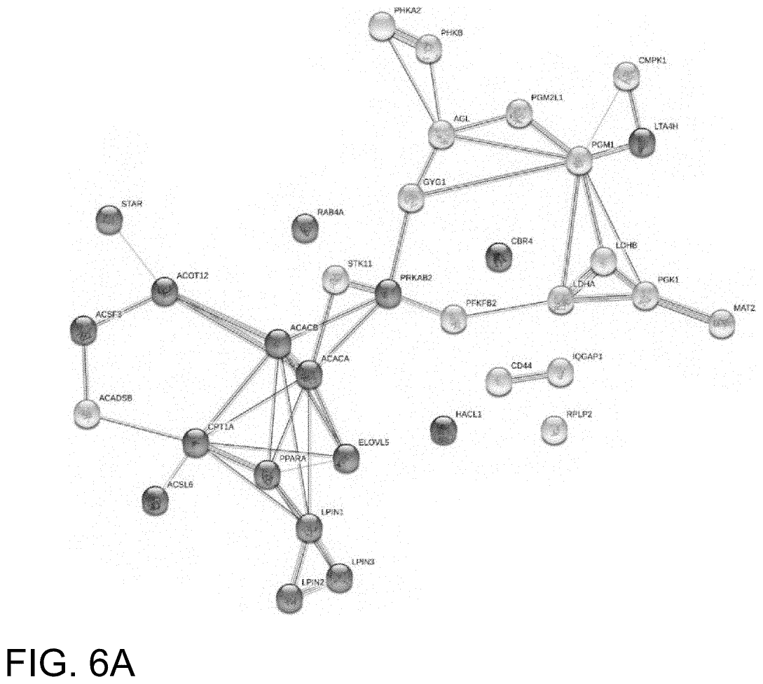

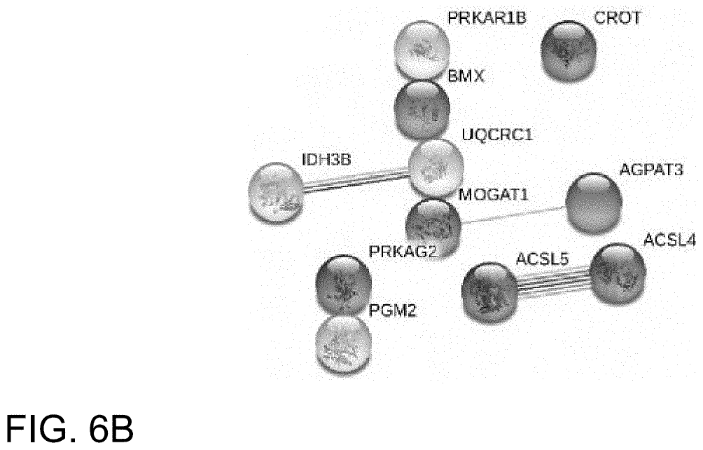

In the liver, at both D14 and D42, within the metabolism pathway, the unique protein interaction groups were enriched for “Metabolism of lipids” and “Fatty acid metabolism” (FIGS. 6 A and B). Thus, despite differences in response to the algae at the two different ages, a major effect was to alter the metabolism of fats in the gut. As the liver is a major processor of lipids and fats, and lipid metabolism is altered in the gut. This result is consistent with the data described above.

FIGS. 6A and 6B illustrate novel metabolism reactome pathway members in the liver at D14 and D42 respectively. Proteins that were unique to each time point within the metabolism reactome pathway were input into STRING to generate protein-protein interaction groups. Red proteins are members of the “Metabolism of Lipids” pathway and purple proteins are members of the “Fatty acid metabolism” pathway for both D14 (A) and D42 (B).

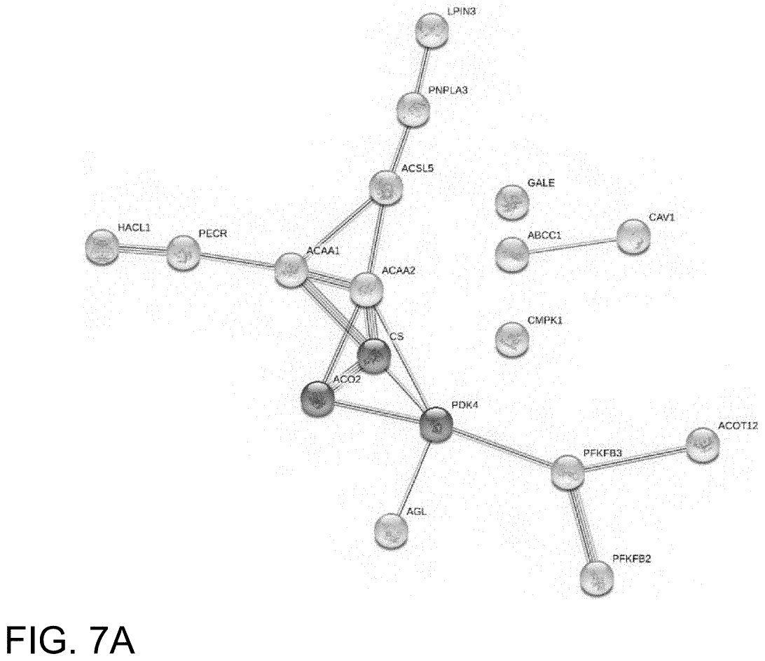

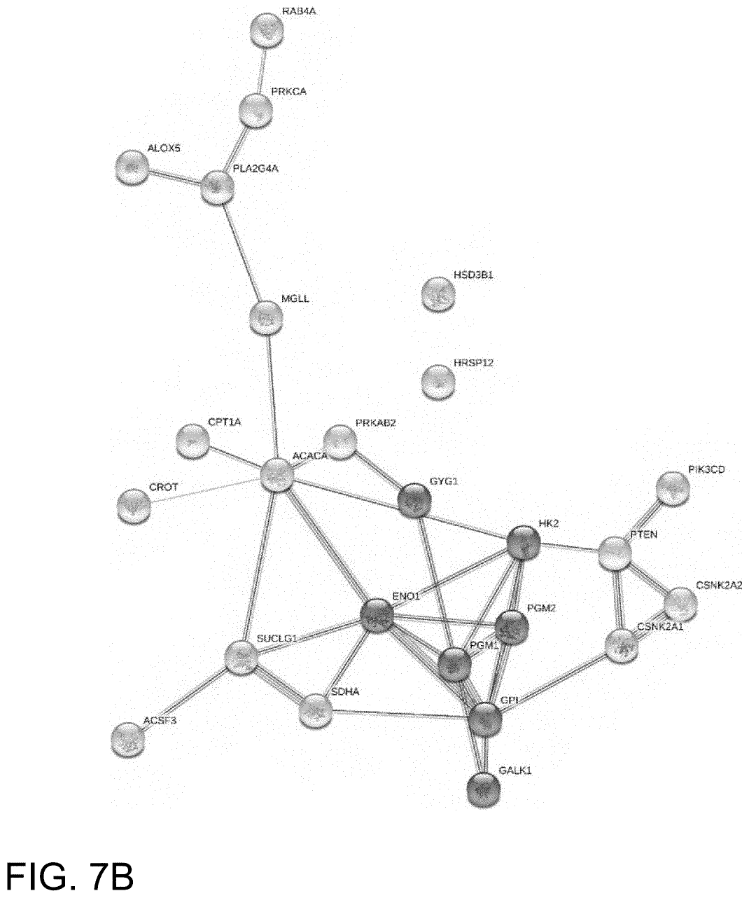

In the muscle, at both D14 and D42, within the metabolism pathway, the unique protein interaction groups were enriched for “Pyruvate metabolism and TCA cycle” and “Metabolism of carbohydrates”, respectively (FIG. 7). Thus, a major effect of the algae supplementation was to alter the TCA cycle early and the metabolism of carbohydrates late. As the muscle is a major consumer of glucose, this is consistent with increased muscle deposition and thus growth. This may even signal a greater feed conversion ratio potential.

FIGS. 7A and 7B illustrate novel metabolism reactome pathway members in the muscle at D14 and D42 respectively. Proteins that were unique to each time point within the metabolism reactome pathway were input into STRING to generate protein-protein interaction groups. Red proteins are members of the “Pyruvate metabolism and TCA cycle” pathway at D14 (A) and “Metabolism of carbohydrates” at D42 (B).

In the ceca, at D14, within the metabolism pathway, the unique protein interaction groups were enriched for “Metabolism of Lipids” (FIG. 7). Again, a major effect of the algae supplementation can be observed to alter lipid metabolism early. There were no significant protein interaction groups or enrichment of function in the ceca at D42. Thus, most of the unique changes occurred early within metabolism. Consistent with the small intestinal tissue metabolic data, lipid metabolism was altered in the gut by the algae.

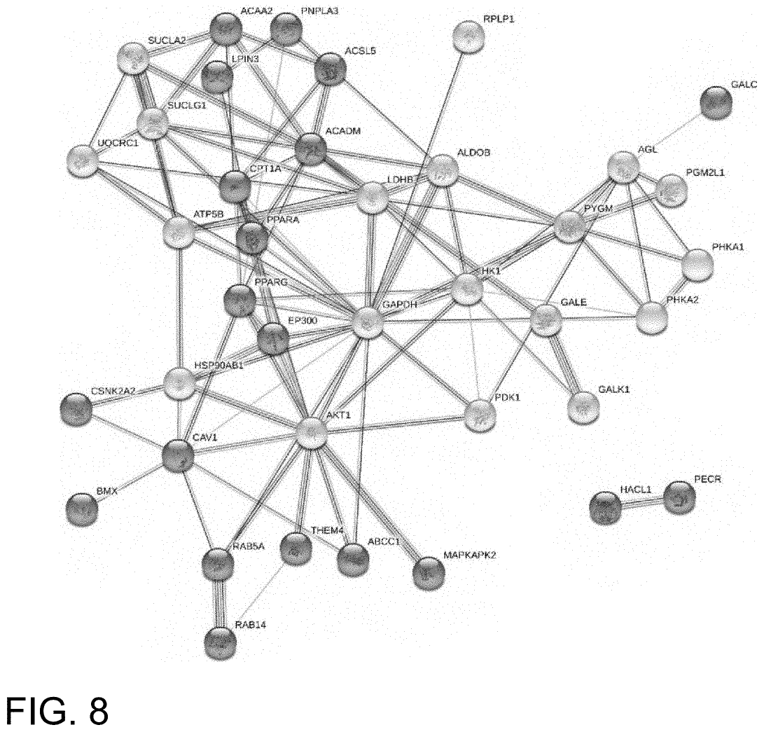

FIG. 8 illustrates the novel metabolism reactome pathway members in the ceca. Proteins that were unique to each time point within the metabolism reactome pathway were input into STRING to generate protein-protein interaction groups. Red proteins are members of the “Metabolism of Lipids” pathway at D14 (A). D42 did not display any significant protein interaction groups and thus is not shown.

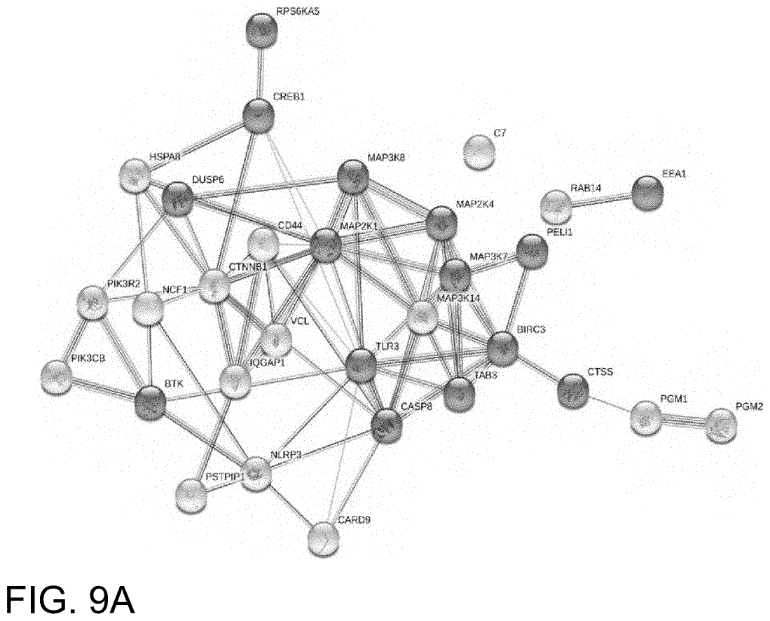

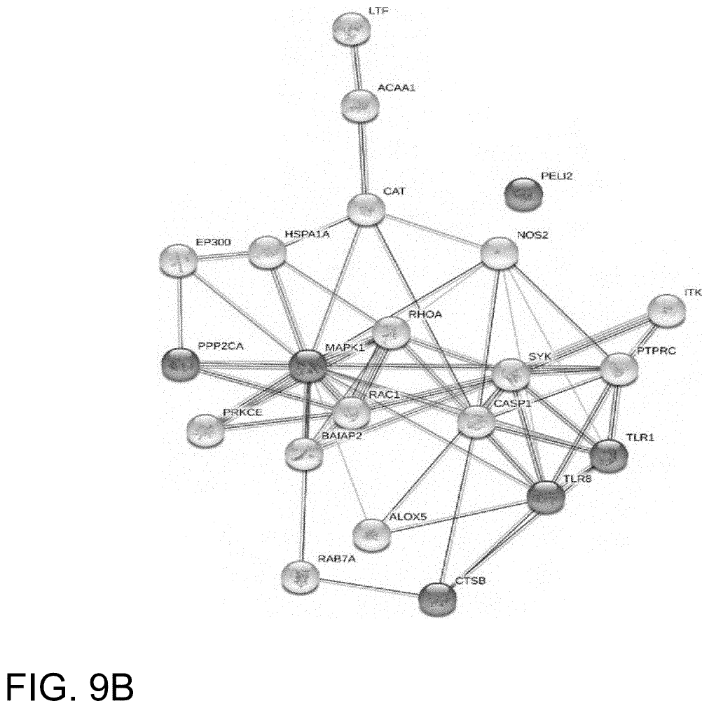

In all tissues and time points innate immune system was present in the top twenty significant reactome pathways, indicating this immune response was significantly changed between algae supplementation and the control (Tables 1-4). The significantly differentially phosphorylated proteins within the Innate Immune System pathway were compared between D14 and D42 for each tissue. Those proteins that were unique to the time point were uploaded into STRING. Within the resulting protein interaction groups (FIGS. 9-12), Toll-like signaling was enriched in all cases with the exception of ceca and liver at D42. The fact that this pathway was not present in these two tissues' unique responses at D42 is further evidence that the main effects of the algae supplementation occur early in grow-out.

FIGS. 9A and 9B illustrate novel innate immune system reactome pathway members in the small intestine (Meckel's adjacent) at D14 and D42 respectively. Proteins that were unique to each time point within the innate immune system reactome pathway were input into STRING to generate protein-protein interaction groups. Red proteins are members of the “Toll-like receptor cascades” pathway for both D14 (A) and D42 (B).

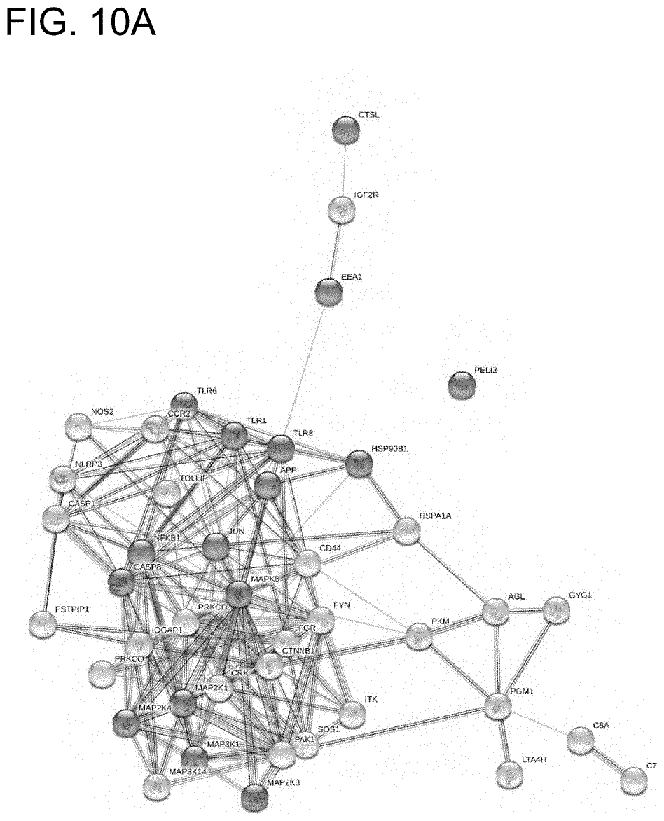

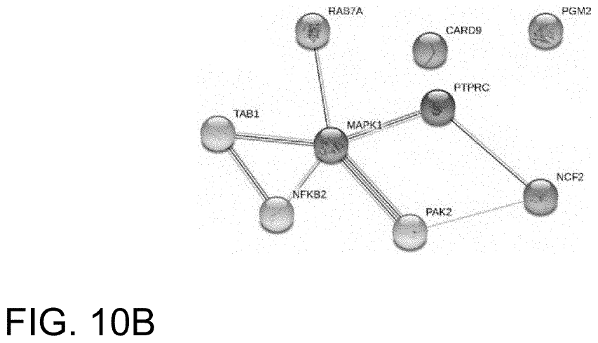

FIGS. 10A and 10B illustrate the novel innate immune system reactome pathway members in the liver at D14 and D42 respectively. Proteins that were unique to each time point within the innate immune system reactome pathway were input into STRING to generate protein-protein interaction groups. Red proteins are members of the “Toll-like receptor cascades” pathway for D14 (A). There was no “Toll-like receptor cascades” pathway found at in D42 (B).

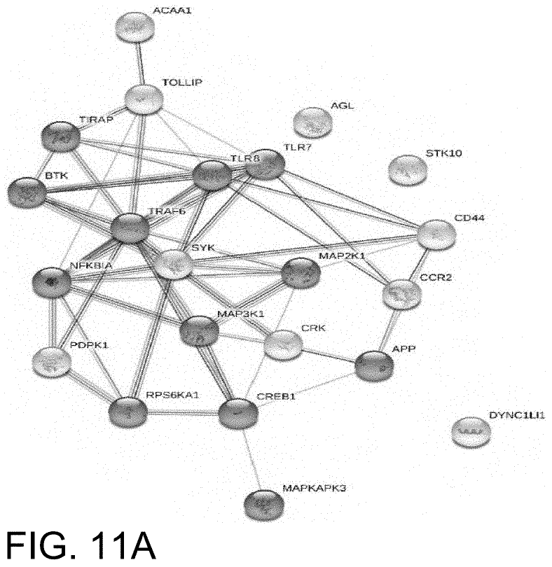

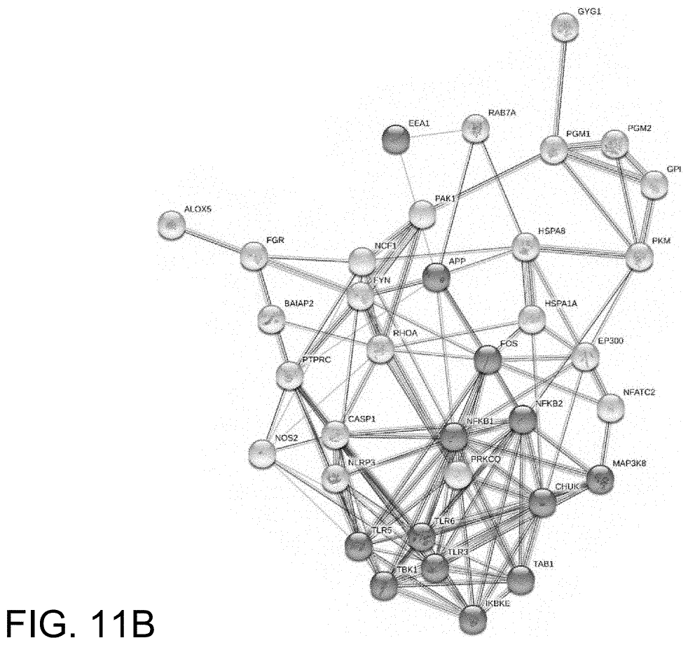

FIGS. 11A and 11B illustrate novel innate immune system reactome pathway members in the muscle at D14 and D42 respectively. Proteins that were unique to each time point within the innate immune system reactome pathway were input into STRING to generate protein-protein interaction groups. Red proteins are members of the “Toll-like receptor cascades” pathway for D14 (A). No “Toll-like receptor cascades” pathway was found at in D42 (B).

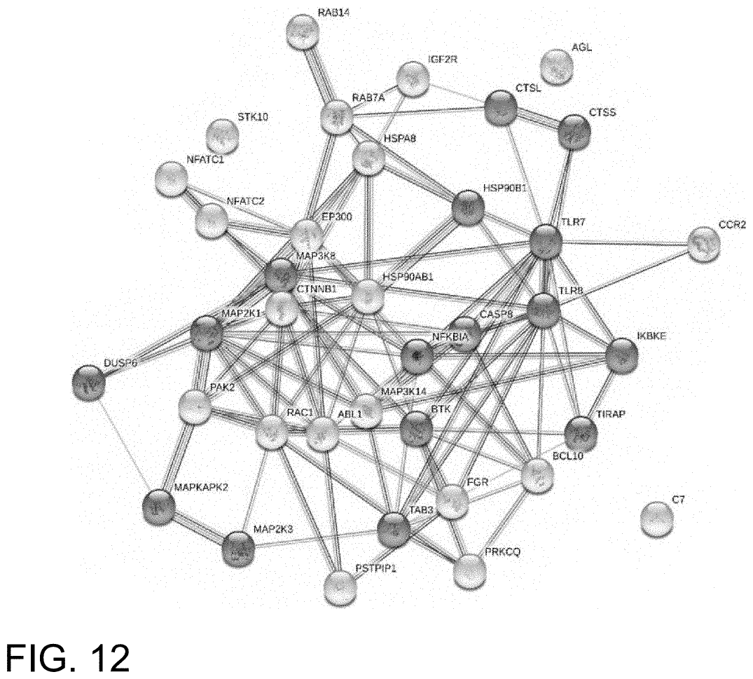

FIG. 12 illustrates novel innate immune system reactome pathway members in the ceca. Proteins that were unique to each time point within the innate immune system reactome pathway were input into STRING to generate protein-protein interaction groups. Red proteins are members of the “Toll-like receptor cascades” pathway for D14 (A). No protein interaction group could be generated for D42.

Results

In general, analysis of the results supports the conclusion that inclusion of the innovative compound as part of a convention diet demonstrated a significant increase in metabolism and increased innate immune response. Moreover, following administration of the disclosed compound on selected birds, samples of both composition-fed birds and birds fed the control diet were examined by gross necropsy which included internal examination. Kinomic analysis of tissues collected from sacrificed birds fed the dietary mixture of the inventive compound and conventional feed confirmed that the biomass alters multiple growth-related pathways as proposed, thus initiating pathway modulation.

The results are summarized as follows:

Tissue kinotypes cluster predominantly by tissue type, within those clusters D14 control diet was distinct.

When tissue samples were compared to their time-matched controls (peptide FC=T2/T1) and the resulting data was clustered, D14 tissue from algae supplemented birds clusters together, regardless of tissue type.

Overall, the algae product significantly alters immunometabolism in all tissues (reference may be had to the pathway tables illustrated above).

The differences between D14 and D42, given algae supplementation, can be explained by:
a more innate response early and adaptive response late in the small intestine
more TLR signaling early compared to late in the liver
more NTRK signaling early in the muscle
more AKT and MyD88 dependent TLR signaling late in the ceca

When the metabolic response of the unique proteins for each time point is considered the following are found:
Metabolism of lipids in the small intestine
Metabolism of lipids and fatty acid metabolism in the liver
Pyruvate metabolism and TCA cycle early and metabolism of carbohydrates late in the muscle
Metabolism of lipids in the ceca early and no significant unique changes late

When the innate immune response of the unique proteins for each time point are considered Toll-like receptor cascades appear in all tissue except liver and ceca at D42.

Overall the algae supplementation appears to mature the tissue earlier then control, induce an immune stimulatory response that shifts the small intestine to a more adaptive response, induce lipid metabolism in all tissues but the muscle and induce an immune response in all tissue.

What is claimed is:

1. A method for altering signaling in multiple growth-related pathways in an animal, the method comprising orally administering to the animal an effective amount of a composition derived from the group consisting of a biomass or a supernatant from an algal culture, a biomass consisting of Gram-negative bacteria, and one or more of a lipopolysaccharide, Lipid A, and fractions, derivatives, and cellular components thereof, derived from Gram-negative bacteria, the method including the step of initially administering to the animal the effective amount of the composition beginning in the early life stage of the animal.

2. The method for altering signaling of claim 1, wherein the altered pathway is selected from the group consisting of the pathway associated with the vascular endothelial growth factor (VEGF), the mitogen-activated protein kinase (MAPK or MAP kinase), Ak strain transforming (Akt), and the neurotrophic tropomyosin-related kinase (NTRK).

3. The method for altering signaling of claim 1, wherein the altered pathway is a growth-related pathway.

4. The method for altering signaling of claim 3 wherein the alteration is caused by modulation of one or more of the growth-related pathways.

5. The method for altering signaling of claim 1, whereby the composition is mixed with a feed ration portion prior to feeding the animal.

6. The method of claim 5, wherein the composition derived from the biomass or the supernatant is fed to the animal in an amount providing from about 0.5 lbs. composition per ton of finished feed to about 11.0 lbs. composition per ton of finished feed.

7. The method of claim 5, wherein the composition derived from the biomass or the supernatant is fed to the animal in an amount providing from about 1.0 lbs. composition per ton of finished feed to about 5.0 lbs. composition per ton of finished feed.

8. The method of claim 5, wherein the composition derived from the biomass or the supernatant is fed to the animal in an amount providing from about 3.0 lbs. composition per ton of finished feed to about 4.0 lbs. composition per ton of finished feed.

9. The method of claim 1 wherein the composition comprising the lipopolysaccharide derived from Gram-negative bacteria composition is adapted for maturation of immune and metabolic processes in poultry.

10. A method for promoting growth and priming the immune system in an animal utilizing a composition derived from one or more of a lipopolysaccharide, Lipid A, and fractions, derivatives, and cellular components thereof, of gram-negative bacteria, the method comprising orally administering to the animal an effective amount of a composition derived from the group consisting of a biomass or a supernatant from an algal culture, a biomass consisting of Gram-negative bacteria, and a lipopolysaccharide derived from Gram-negative bacteria, whereby one or more growth-related pathways in the animal is altered by the composition.

11. The method for promoting growth of claim 10, wherein the altered pathway is selected from the group consisting of the pathway associated with the vascular endothelial growth factor (VEGF), the mitogen-activated protein kinase (MAPK or MAP kinase), Ak strain transforming (Akt), and the neurotrophic tropomyosin-related kinase (NTRK).

12. The method for altering signaling of claim 10 wherein the alteration is caused by modulation of one or more of the growth-related pathways

13. The method for altering signaling of claim 10, whereby the composition is mixed with a feed ration portion prior to feeding the animal.

14. The method of claim 13, wherein the composition derived from the biomass or the supernatant is fed to the animal in an amount providing from about 20.0 g composition per ton of finished feed to about 250.0 g composition per ton of finished feed.

15. The method of claim 13, wherein the composition derived from the biomass or the supernatant is fed to the animal in an amount providing from about 125.0 g composition per ton of finished feed to about 175.0 g composition per ton of finished feed.

16. The method of claim 13, wherein the composition derived from the biomass or the supernatant is fed to the animal in an amount providing from about 100.0 g composition per ton of finished feed to about 150.0 g composition per ton of finished feed.

17. A composition for altering immune and metabolic processes in animals, the composition comprising effective amounts of a dry or liquid feed ingredient is a biomass selected from the group consisting of an algal biomass, a bacterial biomass, and a one or more of lipopolysaccharide, Lipid A, and fractions, derivatives, and cellular components thereof, derived from Gram-negative bacteria, the composition being provided to the animal in sufficient quantities so as to alter one or more growth-related pathways.

18. The composition of claim 17, wherein the altered pathway is selected from the group consisting of the pathway associated with the vascular endothelial growth factor (VEGF), the mitogen-activated protein kinase (MAPK or MAP kinase), Ak strain transforming (Akt), and the neurotrophic tropomyosin-related kinase (NTRK).

19. The composition of claim 17, wherein consumption of the composition by the animal causes modulation of one or more of the growth-related pathways

20. The composition of claim 17, wherein the composition is mixed with a feed ration portion prior to feeding the animal.
